(19) United States
(12) Patent Application Publication
(10) Pub. No.: US 2017/0003966 A1
(43) Pub. Date: Jan. 5, 2017

(54) PROCESSOR WITH INSTRUCTION FOR INTERPOLATING TABLE LOOKUP VALUES

(71) Applicant: Microsoft Technology Licensing, LLC, Redmond, WA (US)

(72) Inventors: Ryan Haraden, Duvall, WA (US); Michael Fenton, Palo Alto, CA (US); Robert Shearer, Woodinville, WA (US); Steven M. Wheeler, North Bend, WA (US)

(73) Assignee: Microsoft Technology Licensing, LLC, Redmond, WA (US)

(21) Appl. No.: 14/788,277

(22) Filed: Jun. 30, 2015

(51) Int. Cl. G06F 9/32; G06F 9/38; G06F 9/30

(52) U.S. Cl. CPC G06F 9/32; G06F 9/30145; G06F 9/3887; G06F 9/3889

(57) ABSTRACT

Apparatus and methods are disclosed for performing mathematical operations that can be applied in a number of processor architectures. In one example of the disclosed technology, a lookup table is configured to return two or more function values based on an input operand of a single processor instruction storing a fixed-point number. A control unit is configured to execute the instruction by addressing the lookup table based on an index portion of the input operand, and an interpolation module is configured to interpolate an output value based on two or more of the returned function values by scaling at least one of the returned function values by a fractional portion of the input operand. In some examples, a second instruction can be used to store the function values in the lookup table.

### BACKGROUND

Microprocessors have benefited from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years.

### SUMMARY

Methods, apparatus, and computer-readable storage media are disclosed for performing complex arithmetic operations using a single processor instruction. In certain examples of the disclosed technology, a processor is configured to execute a single processor instruction to produce two or more function values be performing table lookups based on an input operand of the instruction, generate an output value by interpolating a value based on the produced function values, and produce the interpolated value as an output operand of the single processor instruction. The disclosed techniques can be implemented in general purpose central processing unit (CPU), graphics processing units (GPU), vector processors, or other suitable processors. In some examples, the disclosed techniques allow for improved processing efficiency and/or energy savings. In some examples, the single instruction includes a single instruction multiple data (SIMD) operand.

In some examples of the disclosed technology, each “lane” or “slot” of a multi-operand SIMD register will be used for a table lookup. In some examples, the lookup table is preloaded to support various mathematical operations, for example, trigonometric operations, texture operations, or other mathematical functions. The results received from the table lookup can then be interpolated in order to determine a result. The resulting data can then be stored as the output of the single instruction, for example, in a processor register or in memory.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a multi-core processor, as can be used in some examples of the disclosed technology.

FIG. 2 illustrates a processor core, as can be used in some examples of the disclosed technology.

FIG. 3 outlines an example microarchitecture of a processor core, as can be used in some examples of the disclosed technology.

FIG. 4 illustrates portions of pseudocode used to illustrate examples of the disclosed technology.

FIG. 5 illustrates example processor instructions, as can be used in certain examples of the disclosed technology.

FIG. 6 is a flowchart illustrating an example method of performing a mathematical operation using a single processor instruction, as can be performed in some examples of the disclosed technology.

FIG. 7 is a flowchart illustrating an example method of performing a mathematical operation, including using a lookup table and subsequent mathematical operations, as can be performed in some examples of the disclosed technology.

FIG. 8 is a diagram of an example computing system in which some described embodiments can be implemented.

FIG. 9 is an example mobile device that can be used in conjunction with at least some of the technologies described herein.

FIG. 10 is an example cloud-support environment that can be used in conjunction with at least some of the technologies described herein.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application, or a software application that is accessed or downloaded via a web browser or other software application (such as a remote computing application). Such software can be executed, for example, on a single local computer (e.g., a thread executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technology

Novel operations performed with a processor are disclosed. In some examples, low-power processing is achieved based at least in part on performing mathematical operations using a single processor instruction.

Processors with vector or single instruction multiple data (SIMD) instruction sets can be used in hand, gesture, or depth processing. Such processors are typically designed to be very low power. However, it is often desirable to perform fairly complex math operations, but accuracy can be reduced in order to reduce the compute power requirements of performing such operations. In some examples, a lookup table and interpolation is used to support the processor functions in a low power fashion. In some examples, a unique set of instructions are provided that are natively available in a processor Instruction Set Architecture (ISA) to increase performance and/or save energy.

In some examples, combining a SIMD instruction set with a table lookup and subsequent interpolation provides a lower power processor, which is desirable in, for example, mobile hardware applications, while simultaneously realizing higher performance due to a reduction in of the number of operations performed, including associated overhead, thereby further increasing energy savings.

In some examples of the disclosed technology, each “lane” or “slot” of a SIMD register is be used for a respective table lookup. A pre-loaded lookup table is accessed to support a number of operations, including mathematical operations. In other examples, the lookup table can be fixed (e.g., using a read-only memory (ROM) to realize further energy savings. Results of table lookups are interpolated. The outputs can be stored in the same SIMD register as the source operands (e.g., an operation on a four-lane SIMD operand results in a four-operand output) or in a different register.

### III. Example Processor Implementation

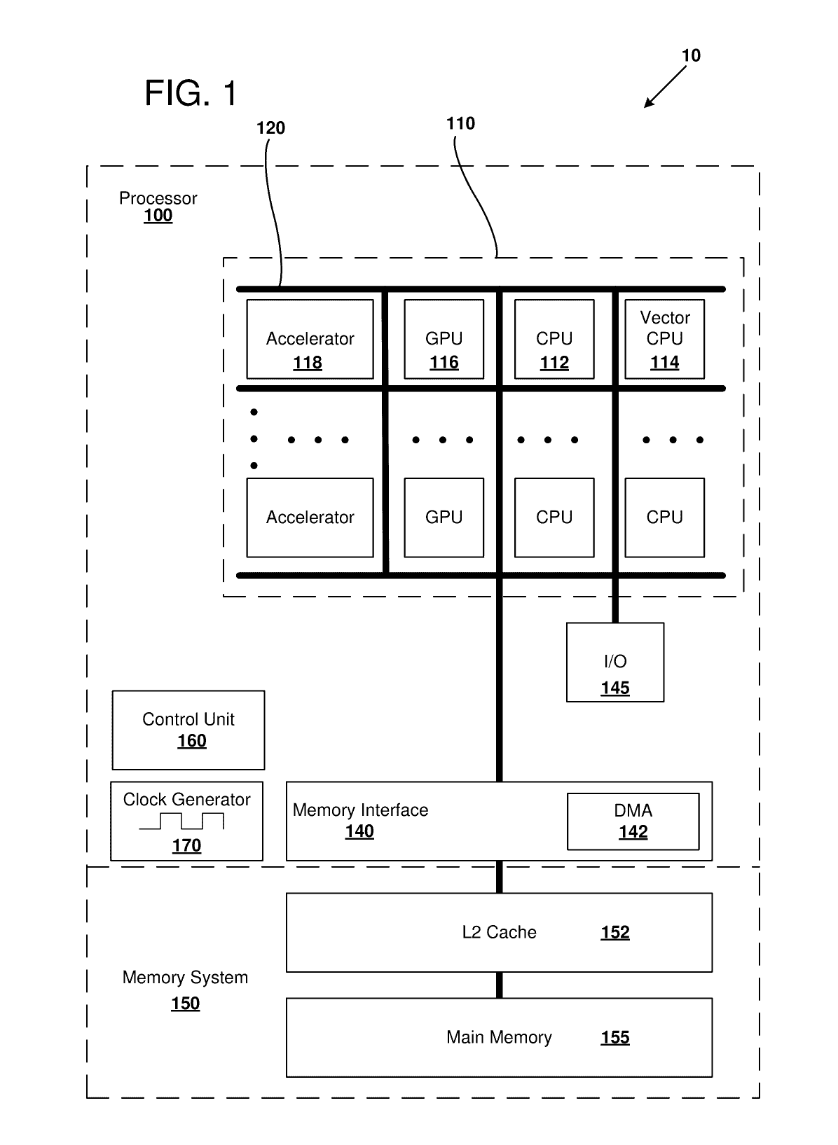

FIG. 1 is a block diagram 10 of a multi-processor 100 in which disclosed techniques and apparatus can be implemented in some examples of the disclosed technology. The processor 100 is configured to execute instructions according to an instruction set architecture (ISA) which describes a number of aspects of processor operation including a register model, a number of defined operations to be performed by processor instructions, a memory model, interrupts, and other architectural features. The multi-processor 100 includes a plurality 110 of functional cores, including: general purpose processors (e.g. CPU 112), vector processors (e.g. vector CPU 114), graphics processing units (e.g. GPU 116), and other computational accelerators (e.g. accelerator 118). The processing units 110 are connected to each other via interconnect 120. The computational accelerators can include hardware for performing a number of different functions, including audio encoding/decoding, video encoding/decoding, compression, data swizzling, or other suitable functions.

Furthermore, any of the processing cores 110 have access to a set of registers which are included within, for example, a register file. In some examples, the processor cores 110 share registers within a register file. In other examples, each of the processor cores includes its own dedicated register file. The register files store data for registers to find in the corresponding processor architecture, and can have one or more read ports and one or more write ports.

In the example of FIG. 1, the memory interface 140 of the processor includes an L1 (level one) cache and interface logic that is used to connect to additional memory, for example, memory located on another integrated circuit besides the processor 100. As shown in FIG. 1, an external memory system 150 includes an L2 cache 152 and main memory 155. In some examples the L2 (level two) cache can be implemented using static RAM (SRAM) and the main memory 155 can be implemented using dynamic RAM (DRAM). In some examples the memory system 150 is included on the same integrated circuit as the other components of the processor cores 110. In some examples, the memory interface 140 includes a direct memory access (DMA) controller 142 allowing transfer of blocks of data in memory without using the register file 130, or without using the processor 100. In some examples, the memory interface 140 manages allocation of virtual memory, expanding the available main memory 155. In some examples, the memory interface 140 manages allocation of video RAM used by a graphics display adapter.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The multi-processor 100 can also include a control unit 160. The control unit 160 supervises operation of the multi-processor 100. Operations that can be performed by the control unit 160 can include allocation and de-allocation of cores for performing instruction processing, control of input data and output data between any of the cores, the register file 130, the memory interface 140, and/or the I/O interface 145. The control unit 160 can also process hardware interrupts, and control reading and writing of special system registers, for example the program counter. In some examples of the disclosed technology, the control unit 160 is at least partially implemented using one or more of the processing cores 110, while in other examples, the control unit 160 is implemented using a different processing core (e.g., a general-purpose RISC processing core). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler that is used to allocate instructions for execution on one or more of the processor cores 110. The recited stages of instruction operation are for illustrative purposes, and in some examples of the disclosed technology, certain operations can be combined, omitted, separated into multiple operations, or additional operations added.

The multi-processor 100 also includes a clock generator 170, which distributes one or more clock signals to various components within the processor (e.g., the cores 110, interconnect 120, memory interface 140, and/or I/O interface 145). In some examples of the disclosed technology, all of the components share a common clock, while in other examples different components use a different clock, for example, a clock signal having differing clock frequencies. In some examples, a portion of the clock is gated to allow power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

Also shown in FIG. 1, the memory interface 140 includes a direct memory access (DMA) module 142, which can be used to read from, and write to, memory without loading the associated read/write values into any of the processor cores 110.

While FIG. 1 illustrates a multi-processor configuration, it should be readily understood to one of ordinary skill in the relevant art that the disclosed technologies can be readily adapted to other configurations, including single-processor configurations.

### IV. Example Processor Microarchitecture

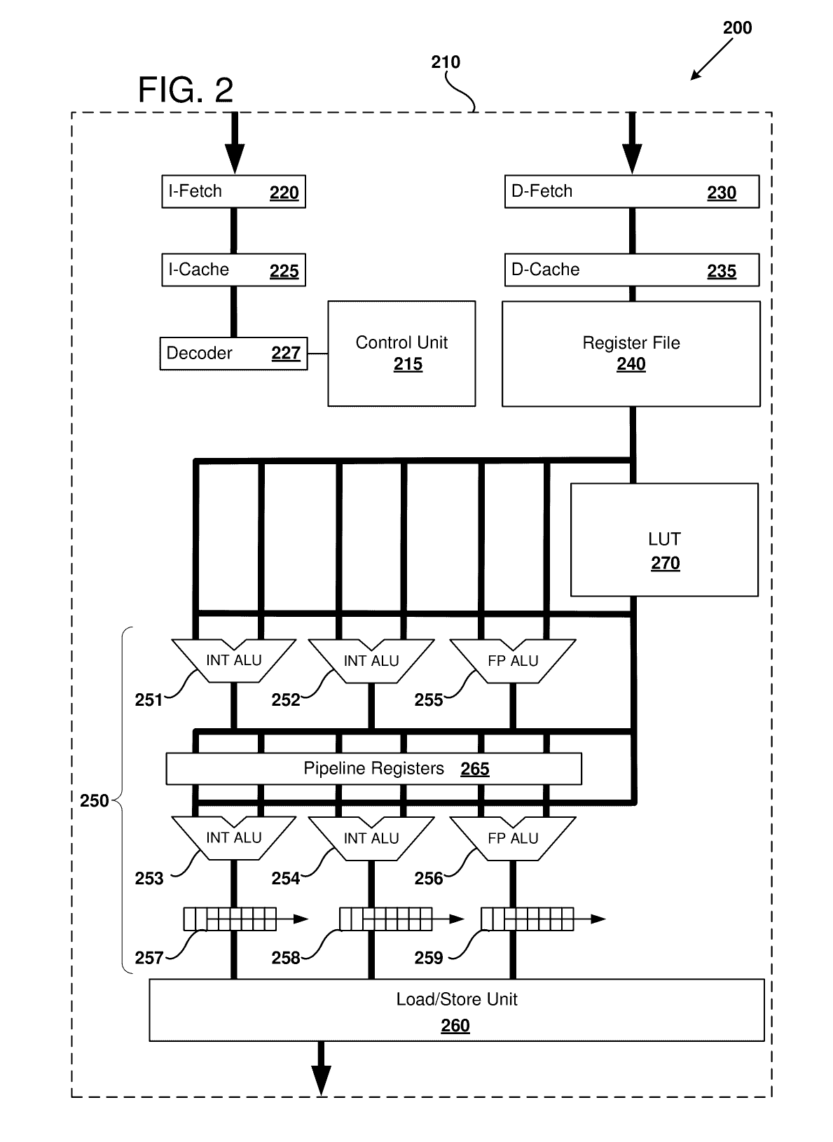

FIG. 2 is a block diagram 200 detailing a generalized example of a micro architecture of a processing unit 210 that can be implemented within any of the processing cores 110, and in particular, an instance of one or more of the processing cores 110, as can be used in certain examples of the disclosed technology. While some connections are displayed in FIG. 2, it will be readily understood to one of ordinary skill in the relevant art that other connections have been omitted for ease of explanation.

The generalized micro architecture illustrated in the block diagram 200 includes a control unit 215, which generates control signals to regulate processor core operation and schedules the flow of instructions within the core. For example, the control unit 215 can initiate execution of processor instructions using an instruction fetch unit 220 which accesses the processor memory system 150 in order to fetch one or more processor instructions and store the fetched instructions in an instruction cache 225. Instructions stored in the instruction cache 225 in turn are decoded using an instruction decoder 227. The instruction decoder decodes opcodes specified within the machine language instructions in order to specify operations to be performed and controlled by the control unit 215.

The control unit 215 can be implemented using any suitable technology for generating control signals to regulate and schedule operation of the core. In some examples, the control unit 215 is implemented using hardwired logic to implement a finite state machine. In other examples, the control unit 215 is implemented using logic coupled to a storage unit storing microinstructions for implementing control unit functions. In some examples, the logic for the control unit 215 is implemented at least in part using programmable logic, while in other examples, the control unit is implemented at least in part using hardwired logic that cannot be easily modified after the control unit has been fabricated in an integrated circuit.

The instruction decoder 227 also specifies instruction operands, including input operands and output operands. The instruction operands can be specified using any suitable addressing modes which, depending on a particular processor implementation, can include register mode, immediate mode, displacement mode, indirect mode, indexed mode, absolute mode, memory indirect mode, auto increment mode, auto decrement code, or scaled mode. In some examples, an instruction has one input operand and one output operand. In other examples, instructions can have more than one input operand, and/or output operand. In other examples, one or more of the input operands, or the output operands, are inferred, instead of being explicitly specified within a particular instruction word.

Some instructions are used to load data into the processing unit 210 using the data fetch module 230. The data fetch module 230 uses the memory system 150 to access data stored in a cache, main memory, or virtual memory, and store the data received from the memory system 150 in a data cache 235. Data stored in the data cache 235 can in turn be loaded into a register file 240 that holds architecturally-defined registers for the processing unit 210.

Also shown in FIG. 2 are a number of execution units 250, which include integer arithmetic logic units (ALU) (e.g. integer ALUs 251 through 254), floating point ALUs (e.g. floating point ALUs 255 and 256), and shifters (e.g. shifters 257 through 259). The execution units receive data from the register file 240 and can store results using a load store unit 260. In some examples, the operation of the execution units 250 can be pipelined using one or more pipeline registers 265 which allow for temporary storage of values in between individual clock cycles.

The execution units can also access data stored in a lookup table (LUT) 270. The lookup table can be implemented using read only memory (ROM), random access memory (RAM), as a register file (e.g. a register file comprising latches and/or flip flops) or other suitable storage technology. In some examples, processing resources, including some or all of the memory accessible to the processing unit 210, including in the LUT 270, can be stored in embedded memory including within a System on Chip (SoC) integrated circuit. The LUT 270 can have one or more read ports and one or more write ports, depending on the particular configuration. For example, if the processing unit 210 is a SIMD processor processing four 16-bit words of data simultaneously, the LUT 270 can output data 64 bits in width, or 16 bits in width for each lane of SIMD data. In some examples, the LUT 270 can be programmed using one or more dedicated processor instructions. In other examples, the LUT can be pre-programmed (e.g. as in a ROM, flash memory, or other suitable means) by using a dedicated memory address and read/write memory operations, or by other suitable means. The particular configuration of the LUT 270 can be determined by the designer of the processing unit 210 in view of the apparatus and methods disclosed herein.

The execution units can be configured to form an interpolation module. For example, the control unit 215 can generate control signals for performing operation of a single instruction that cause some of the execution units to subtract one function value returned by the LUT 270 from a second function value, multiply the subtraction result from the first function value, and shift the multiply result right to generate an output value using, for example, the integer ALUs 251 and 253, and the shifter 257. In other examples, the interpolation module is implemented using dedicated adders, subtractors, multipliers, and/or shifters. In some examples, the control unit 215 pipelines a single instruction by performing some operations for the instruction in a first pipeline stage and performing other operations for the same instruction in one or more subsequent pipeline stages, such that execution of the other operations occurs during a different clock cycle than for the first pipeline stage operations. Intermediate results can be stored using the pipeline registers 265. In some examples, the control unit 215 is a general purpose control unit that also supervises operation of other instructions for the processor core 210. Thus, implementation of the single instruction can be integrated into a general-purpose processor core, reducing overhead and allowing for improved energy efficiency.

### V. Example Execution Unit

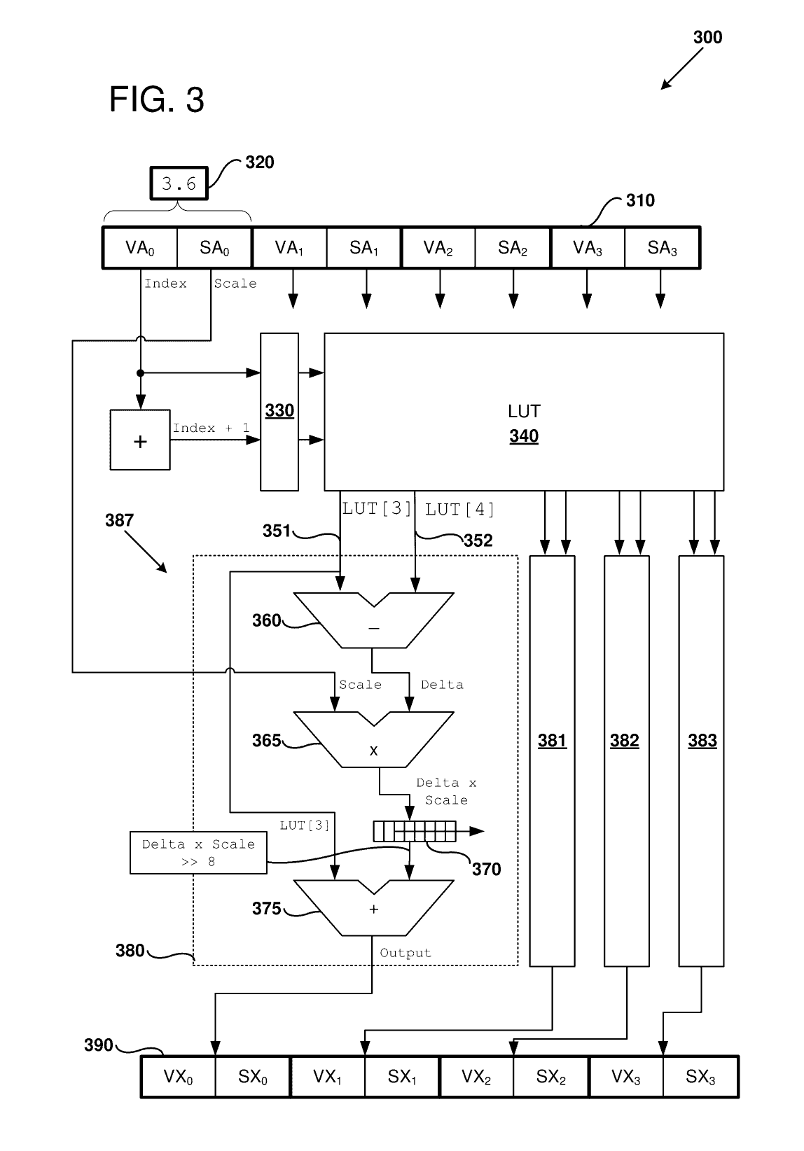

FIG. 3 illustrates a particular configuration of an execution unit, as can be used in certain examples of the disclosed technology. For example, the example configuration illustrated in the block diagram 300 of FIG. 3 could be used as a particular arrangement of the functional units 250 and LUT 270 of the processing unit 210 discussed above regarding FIG. 2.

As shown in FIG. 3, a 64-bit word of fixed-point SIMD data 310 is depicted. The SIMD data 310 is broken into four individual “lanes,” each of which contains fixed-point data including an 8-bit index and an 8-bit scale. For example, the fixed-point number, 3.6 (reference numeral 320), has an index value of 3 and a scale value of 0.6. It should be noted that in this example, the index value 3 can be represented as a binary number (3 (0b00000011) and the scale value 0.6 is represented as a fractional binary number (0b10011001). In other examples, the number of bits in a SIMD operand, or the number of bits dedicated to a fixed-point index and/or scale can be varied. In other examples, a scalar value is used instead of SIMD data 310. It should be readily understood to one of ordinary skill in the relevant art that the width of the data 310 can vary as well. The block diagram 300 of FIG. 3 highlights operations that are performed on one SIMD operand 320 of a single processor instruction. Details of the other three operands are omitted from FIG. 3 for ease of explanation.

As shown in FIG. 3, the index portion VA₀ of the first SIMD operand 320 is used to generate an address using an address generator 330. The address generator in turn applies the calculated address to the lookup table (LUT) 340, which has been previously stored with a number of values. In the depicted example, the index value VA₀ is translated to a LUT address value. Further, one (1) is added to the index value, and the result is also translated to a corresponding address in the LUT 340. In some examples, the index data is such that address translation is not necessary, that is, the index values can be used directly to address the LUT 340. The index values can also be normalized, according to a fixed normalization or a dynamic normalization.

The examples of lookup tables disclosed herein (e.g. LUT 340) describe examples where a single index value is used to calculate and address for performing a table lookup. However, as will be readily understood to one of ordinary skill in the art, the lookup table can be addressed using multiple indices, for example two, three, or more indices, thereby forming a multi-dimensional lookup table.

As shown in FIG. 3, the LUT 340 has 8 read ports. The illustrated LUT 340 outputs a first read value 351 (LUT[3], e.g., 100), which corresponds to a data value stored for the address corresponding to an index value of 3, while the second read port 352 (LUT[4], e.g., 150) outputs a stored value that corresponds to the lookup table value corresponding to an index value of 4. The function values 351 and 352 output by the LUT 340 are applied to a first ALU 360 which has been configured to subtract the first function value 351 from the second function value 352, thereby calculating the delta of the first and second function values (e.g., LUT[4]−LUT[3]=150−100=50). A second ALU 365 is configured to multiply a scale portion SA₀ of the input operand 320 by the delta value calculated by the ALU 360. This scaled value is in turn output to a right shift module which shifts the data by a pre-determined amount. For example, the data can be scaled by one-half the width of the input operand 320 (here, 8 bits). The shifted and scaled value output by the shifter 370 is then added to the first function value 351 by a third ALU 375, thereby generating a resulting output value for the first SIMD operand 320 of the SIMD data word 310. The functional units 360, 365, 370, and 375 thus form one execution lane 380 of the processing unit 210. There are three other execution lanes 381, 382, and 383 shown in FIG. 3, which operate on the other three operands of the SIMD data 310 in a similar fashion as the execution lane 380. When the depicted execution unit is configured to execute a single instruction for performing combined table lookup and interpolation operations, the combination of one or more execution lanes (e.g., execution lanes 380-383) thereby forms an interpolation module 387 configured to interpolate at least one respective output value based on the two or more respective function values output by the LUT 340, for each corresponding execution lane of the execution unit. The results of the four SIMD operations are in turn stored in a SIMD output register 390, which can also be expressed in a fixed-point format (as shown with an 8-bit index (e.g., VX₀) and an 8-bit fractional portion (e.g., SX₀)).

It should be readily understood to one of the ordinary skill in the art that the configuration of the functional units within each of the SIMD lanes (e.g. SIMD lane 380) can be varied. For example, instead of using general purpose ALUs such as ALUs 360, 365, and 375, dedicated adders, multipliers, or other circuits can be employed. Further, there are different circuit implementations that can be used to implement the shifter 370. Further, in some examples one or more sets of pipeline registers can be interposed between one or more of the functional units in order to add pipeline stages to the execution of the processing unit displayed in block diagram 300.

### VI. Example Pseudocode

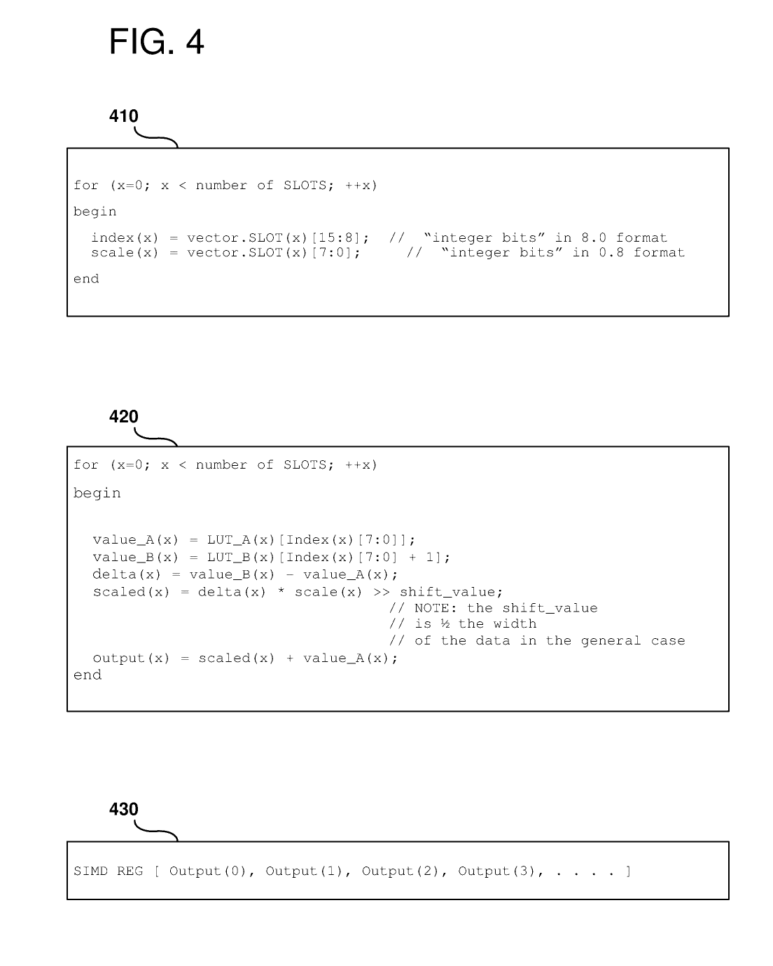

FIG. 4 includes three portions of pseudocode describing an example arrangement of functional units as can be used in implementing certain apparatus and methods disclosed herein. A first portion 410 of pseudocode describes extracting index (index(x)) and scale (scale(x)) values from a number of slots of data expressed in a SIMD format. In particular, the code portion 410 includes an 8 bit index portion, which extracts the whole integer portion of a SIMD operand (vector.SLOT(x)[15:8]), as well as a fractional portion (vector.SLOT(x)[7:0]) of a SIMD operand. In the example shown, the scale portion of the SIMD operand is expressed as a fractional binary number, although other representations can be used.

A second portion 420 of pseudocode describes performing lookup table lookups and interpolations according to the disclosed technology. Two lookup tables operations are performed to look up a first function value (LUT_A(x)) at a location specified by the index portion of a SIMD operand and a second function value (LUT_B(x)), which is used to perform a table lookup at an address specified by the index portion of a SIMD operand plus one. In some examples of the disclosed technology, a different offset can be used, for example, an offset specified by the user using a processor instruction, by storing a value in a particular register or memory location, or by using other suitable means for specifying the offset. Next, a delta (delta(x)) is calculated by subtracting the function value returned by the LUT_B lookup by the function value returned by the lookup table lookup LUT_A. The delta value, in turn, is multiplied by the fractional portion of the SIMD operand (scale(x)) (also referred to as the scale portion of the operand). The delta value is multiplied by the scale and then shifted right a specified number of bits based on the format of the input and stored as the scale value (scaled(x)). For example, an 8.8 format floating point value will be shifted right by 8 bits. The output value (output(x) for the instruction is computed by adding the lookup value LUT_A to the result of the scaling operation.

A pseudocode portion 430 illustrates an example arrangement of output values that can be stored in a particular SIMD register. As will be readily understood to one of ordinary skill in the art, other arrangements of SIMD data are possible.

### VII. Example Processor Instructions

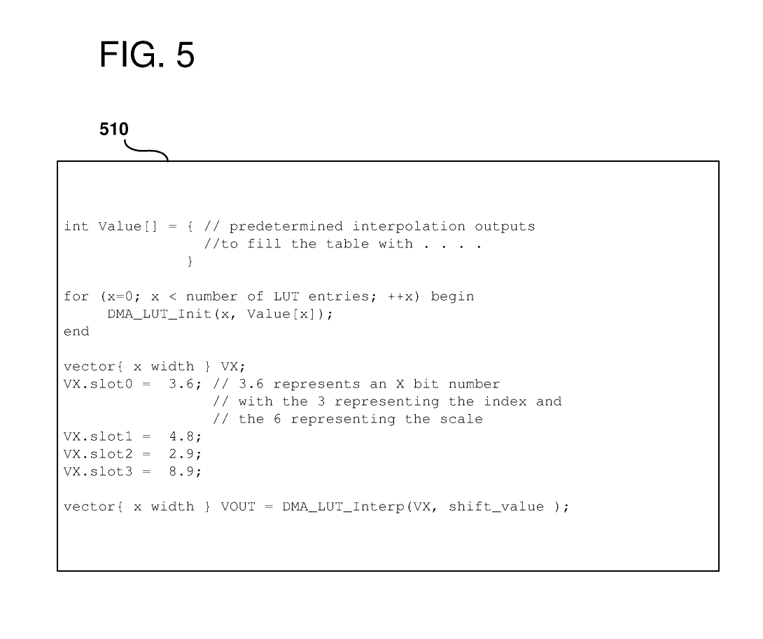

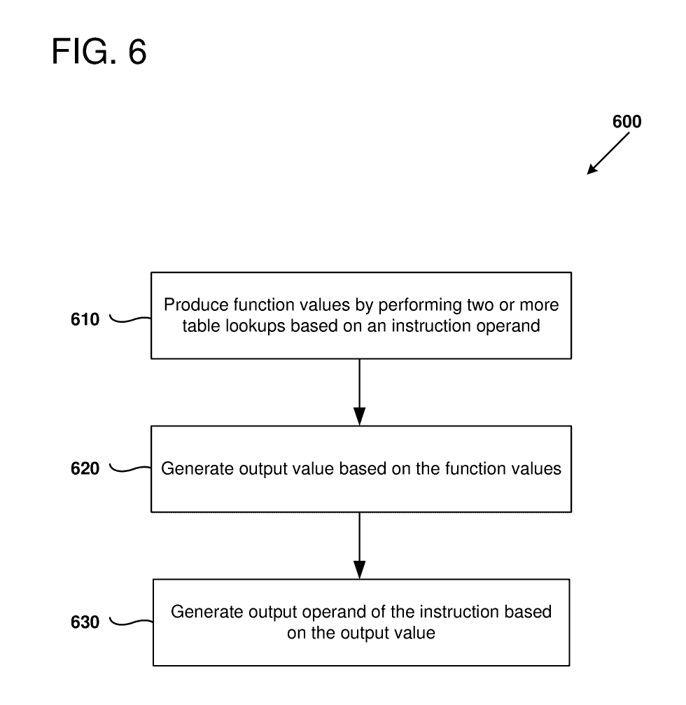

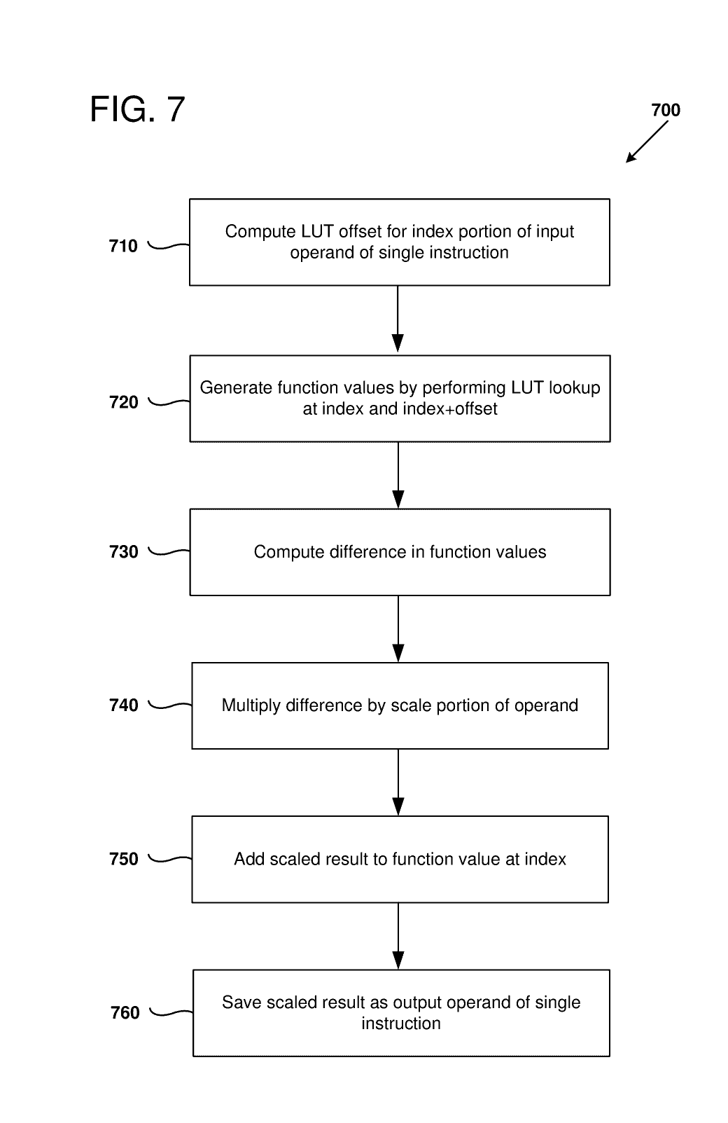

FIG. 5 illustrates a portion 510 of instructions that can be used in order to program a processor implementing technologies disclosed herein. As shown in FIG. 5, a first instruction, DMA_LUT_Init is used to initialize a lookup table (e.g. LUT 340) prior to executing the mathematical operations disclosed herein. The DMA_LUT_Init instruction specifies a start address and an end address in memory and can also include an optional argument specifying the scale of the address (e.g., for normalizing index values to LUT addresses). When a suitably-configured processor executes the DMA_LUT_Init instruction, it will read a series of values starting at the start memory address into the lookup table and store them for future use. The end value defines the end of the range of memory values from which to load lookup table entries. The optional address scale parameter can be used to specify a scaling between an index portion of a SIMD operand which, in turn, can be used to calculate an address within the lookup table. The second instruction assigns a four operand vector of fixed-point numbers to a signed int VX. The third instruction is a single instruction that is used to perform a mathematical operation named DMA_LUT_Interp. The instruction takes as arguments a vector VX and then will perform the operation specified by values stored in the lookup table along with an interpolation operation. For example, the DMA_LUT_Interp instruction can use functional units 380-383 as described above regarding FIG. 3 to perform the methods discussed below regarding FIG. 6 or FIG. 7. The illustrated DMA_LUT_Interp instruction also includes optional parameters offset and normal scale. The offset is used to specify an offset, for example an offset different than 1 for calculating a second function value to be used for interpolation. The normal scale can be used to further define how scaling is performed, for example by specifying the number of bits with which the scale value has shifted or other suitable parameter. As will be readily understood to one of ordinary skill in the relevant art, the disclosed instruction can be adapted with additional parameters in order to perform specific operations.

### VIII. Example Method of Performing Operation with a Single Instruction

FIG. 6 is a flowchart 600 outlining a method of performing a mathematical operation as can be performed in certain examples of the disclosed technology. For example, a suitably programmed processor, for example, the processor 100 configured to run object code compiled from the instructions shown in FIG. 5, can be used to implement the method depicted in FIG. 6. At process block 610, two or more function values are produced by performing two or more table lookups based on an instruction operand. For example, processor 100 is configured to execute a single processor instruction having one input operand. The input operand can be a scalar value, or a portion of a vector of multiple operands, e.g. such as a SIMD register. A first function value can be produced by performing a first table lookup based on an index portion of the input operand. A second function value can be produced by performing a second table lookup based on an address calculated by adding an offset (e.g., 1) to the index portion of the input operand. In some examples, function values are produced for each operand within a multi-operand vector. Once the function values are produced by performing one or more table lookups, the method proceeds to process block 620.

At process block 620, output values are generated by interpolating an output value based on the two or more function values for the input operand. For example an execution unit configured to include the interpolation module 387, as described above regarding FIG. 3, is one suitable way for performing an interpolation. While the examples discussed herein describe linear interpolation, for ease of explanation, it should be readily understood that other suitable forms of interpolation can be employed. For example, polynomial interpretation, spline interpolation, interpolation using three or more function values, or other suitable forms of interpolating can be used. Once one or more output values have been interpolated, the method proceeds to process block 630.

At process bock 630, the method generates an output operand of the instruction based on the output value interpolated at process block 620. In some examples, additional processing is performed to the output value before generating an output operand. For example, additional shifting, sign calculation, or other suitable operations can be performed on the output value. The output operand can be stored in a number of different manners. For example, the output operand can be a register in the processor. Thus subsequent instructions executed by the processor can use the output value as stored in corresponding register. In other examples, the output operand can be stored in memory, for example at an absolute, index, or indirect address, placed on a stack, or output as a signal.

Thus, the method outlined in the flowchart 600 can be used to perform a mathematical operation by executing a single processor instruction. For example, the function values performed by the lookup table are not visible at the architectural level. Similarly, intermediate values generated during interpolating of an output value can also be hidden from the programming model. Because the mathematical operation outlined in FIG. 6 is executed using a single instruction, performance and/or energy reduction benefits can be realized. For example, the outlined method avoids the need for additional read and writes to processor registers while performing the operation, thereby avoiding excess energy usage. Further, the outlined method can be integrated into the normal processor pipeline.

### IX. Example Method of Executing a Processor Instruction

FIG. 7 depicts a flowchart 700 outlining a method of performing a mathematical operation as can be performed in certain examples of the disclosed technology. For example a processor, such as the processor 100 discussed above regarding FIG. 1, as can be used to implement the method of FIG. 7.

At process block 710, an input operand of a single instruction is received, and a lookup table (LUT) offset is computed based on an index portion of the input operand. For example, for a 16-bit fixed-point number expressed in 8.8 format, the 8 most significant bits are used as the index portion. In some examples, the LUT offset is a constant (e.g. plus 1 or minus 1). In other examples, an offset is computed as a function of the index portion of the input operand, the fractional portion of the input operand, a mantissa of a floating point input operand based on a statically or dynamically configurable parameter, or by another operand of the single instruction. Once the LUT offset has been computed, the method proceeds to process block 720. In some examples, the single processor instruction includes a second operand specifying an offset from an index portion of the first input operand and that offset is used in performing an least one of the table lookups performed according to the disclosed method.

At process block 720, function values are generated by performing LUT lookups at an address based on the index as well as the index plus the offset computed at process block 710. For example, if an input operand is a fixed-point number 3.6, the LUT lookup can be performed at an address corresponding to the numbers 3 and 4. As disclosed herein, the function values can be arbitrary, and in some examples can be set by the use of another processor instruction. Once two or more function values are generated by performing the LUT lookup, the method proceeds to process block 730. In some examples, an address used for performing a LUT lookup is based on an index portion of the input operand of a single processor instruction combined with the offset computed at process block 710. In some examples, the processor is configured to calculate an address for the lookup table based on additional considerations, which considerations can be specified by the control unit, by the single processor instruction, by configuring control registers of the processor, or other suitable methods for configuring lookup table address calculation. For example, an address calculated in performing a LUT lookup can be clamped above or below a certain value, wrapped past the end of the lookup table address range back to previous addresses of the lookup table, or limited such that only a portion but not all of the available address locations for the lookup table are used in addressing the lookup table. In some examples, the lookup table values can be updated dynamically as an execution thread is running.

The lookup table can be implemented using any suitable storage technology including DRAM, SRAM, registers, flip flops, latches, flash memory, or other suitable storage technology. As will be readily understood to one of ordinary skill in the relevant art, any arbitrary function can be programmed into the lookup table, for example trigonometric functions, including sine, cosine, tangent, as well as inverse versions of those trigonometric functions. Further, other mathematical functions such as square root, factorial, logarithms, or other suitable mathematical functions can be implemented. Furthermore, table lookups for use in applications such as audio or video processing, encryption, pattern recognition, image processing, or other suitable application can be used.

At process block 730, a difference is computed between the two function values. For example the function value returned by the lookup at index can be subtracted from the function value returned by the LUT lookup at the address corresponding to index plus offset. In other examples, different techniques for computing differences can be used, including but not limited to: bit-wise comparisons, addition, subtraction, multiplication, and/or division, or other mathematical operations. In some examples, the difference is computed by retrieving a value from a lookup table. Once the difference is computed, the method proceeds to process block 740. The different in function values can be computed using an ALU, or a dedicated adder or subtractor.

At process block 740, the difference computed at process block 730 is multiplied by a scale portion of the input operand of the single instruction. For example, if the scale portion is designated as the fractional portion of the input operand, that portion is multiplied by the difference computed at processor block 730. In some examples, the scale portion of the operand is expressed as a fractional binary number. In other examples, a different format of the scale portion is used. Once the difference is multiplied by the scale portion, the method proceeds to process block 750. The different computed at process block 740 can be computed using an ALU, a dedicated multiplier, a shifter, or other suitable logic circuit. After multiplying the difference by the scale portion of the operand, the result can then be shifted by a number of bits equal to one-half the width of the input operand. For example, if the input operand is a 16-bit, 8.8 fixed-point number, then the scaled result is logically shifted to the right by 8 bits. In other examples, a function other than logical right shift is applied to the scaled result (e.g., in examples where interpolation is non-linear). This scaled result can be used by the addition performed at process block 750.

At process block 750, the scaled result generated at process block 740 is added to the function value returned by the table lookup at the address corresponding to the index of the input operand of the single instruction. In other examples, a different mathematical function can be used. For example subtraction, or a bit-wise operation. By adding the scaled result to the function value corresponding to the input operand, an output result value is generated. Once one or more of these output result values are generated, the method proceeds to process block 760. The scaled result can be generated using an ALU, a dedicated adder, or other suitable logic circuit.

At process block 760, the scaled result value generated at process block 750 is saved as at least one output operand of the single instruction. For example, the scaled result value can be stored in a processor register, or at a memory location, which location can be designated using an absolute, relative, indexed address, or other suitable manner of specifying a location to write the output operand. Thus, a complex mathematical operation can be performed using a single processor instruction.

In some examples, the input operand is a scalar value of the single instruction while in other examples, multiple input operands, for example as in a vector processor or SIMD processor, are used so as to allow processing of multiple operands simultaneously for one single instruction. Similarly, the output operand of the method generated at process block 760 can also be a scalar, a vector, or a SIMD register value.

It will be readily understood to one of ordinary skill in the relevant art that intermediate values produced while performing the method outlined in the flowchart 700 may not be architecturally visible. In other words, certain values such as the function values generated at process block 720, the difference computed at process block 730, the multiply result produced at process block 740, or other intermediate values may not be visible to the programmer. This is because the method of FIG. 7 can be integrated into a processor as a base processor instruction, and thus the depicted method can be mapped onto existing processor pipeline states.

In some examples, after performing the method outlined in FIG. 7, an additional one or more processor instructions can be executed and cause the processor to store one or more different values in the lookup table that was used for the table lookups performed at process block 720. After storing these different values, the single instruction can be executed again in order to perform a second operation to generate a different output value as a second output operand of this third processor instruction. In some examples, this third single processor instruction is identical to the instruction executed on the first pass of the method, while in other examples, this third processor instruction is a different instruction, but which executes in a similar fashion, at least in some respects to the first signal instruction. In some examples, a processor is used to execute the method by executing at least one or more of the following types of instructions: vector instructions, single instruction multiple data (SIMD) instructions, multiple instruction multiple data (MIMD) instructions and/or graphic processing unit (GPU) instructions.

In some examples, a method includes transforming one or more source code or assembly code instructions into processor instructions that are executable by the processor and emitting transformed processor instructions as object code for the processor. The object code includes at least one single processor instruction that when executed by the processor causes the processor to perform the method outlined in FIG. 7. In some examples, the object code is stored on one or more computer readable storage medium.

### X. Example Computing System

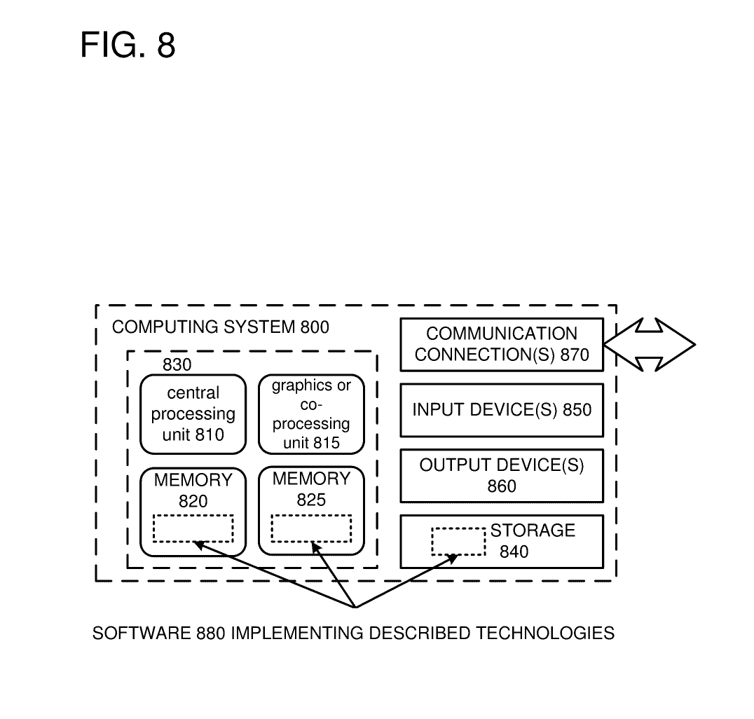

FIG. 8 depicts a generalized example of a suitable computing system 800 in which the described innovations may be implemented. The computing system 800 is not intended to suggest any limitation as to scope of use or functionality, as the innovations may be implemented in diverse general-purpose or special-purpose computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions, including instructions for implementing lookup tables and single instructions for calculating using the lookup tables disclosed herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 8 shows a central processing unit 810 as well as a graphics processing unit (GPU) or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s). The memory 820, 825 stores software 880 implementing one or more innovations described herein, in the form of computer-executable instructions suitable for execution by the processing unit(s).

A computing system may have additional features. For example, the computing system 800 includes storage 840, one or more input devices 850, one or more output devices 860, and one or more communication connections 870. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 may be removable or non-removable, and includes magnetic disks, magnetic tapes or cassettes, CD-ROMs, DVDs, or any other medium which can be used to store information and which can be accessed within the computing system 800. The storage 840 stores instructions for the software 880 implementing one or more innovations described herein.

The input device(s) 850 may be a touch input device such as a keyboard, mouse, pen, or trackball, a voice input device, a scanning device, or another device that provides input to the computing system 800. For video encoding, the input device(s) 850 may be a camera, video card, TV tuner card, or similar device that accepts video input in analog or digital form, or a CD-ROM or CD-RW that reads video samples into the computing system 800. The output device(s) 860 may be a display, printer, speaker, CD-writer, or another device that provides output from the computing system 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### XI. Example Mobile Device

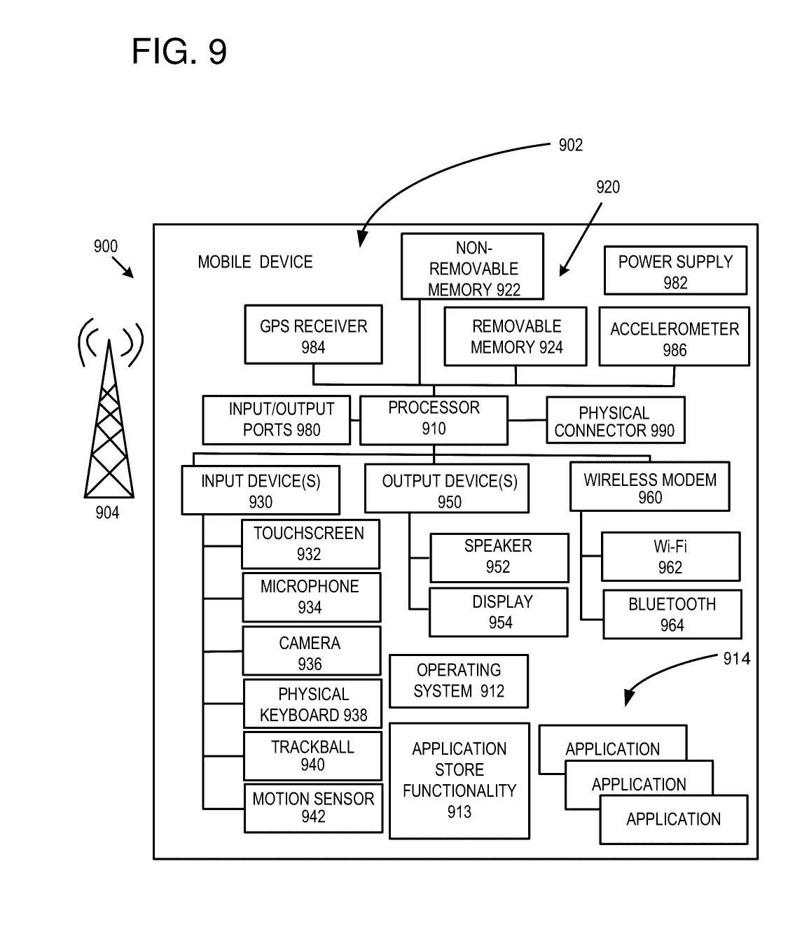

FIG. 9 is a system diagram depicting an example mobile device 900 including a variety of optional hardware and software components, shown generally at 902. Any components 902 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 904, such as a cellular, satellite, or other network.

The illustrated mobile device 900 can include a controller or processor 910 (e.g., signal processor, microprocessor, ASIC, or other control and processing logic circuitry) for performing such tasks as signal coding, data processing, input/output processing, power control, and/or other functions, including instructions for implementing lookup tables and single instructions for calculating using the lookup tables disclosed herein. An operating system 912 can control the allocation and usage of the components 902 and support for one or more application programs 914. The application programs can include common mobile computing applications (e.g., email applications, calendars, contact managers, web browsers, messaging applications), or any other computing application. Functionality 913 for accessing an application store can also be used for acquiring and updating application programs 914.

The illustrated mobile device 900 can include memory 920. Memory 920 can include non-removable memory 922 and/or removable memory 924. The non-removable memory 922 can include RAM, ROM, flash memory, a hard disk, or other well-known memory storage technologies. The removable memory 924 can include flash memory or a Subscriber Identity Module (SIM) card, which is well known in GSM communication systems, or other well-known memory storage technologies, such as “smart cards.” The memory 920 can be used for storing data and/or code for running the operating system 912 and the applications 914. Example data can include web pages, text, images, sound files, video data, or other data sets to be sent to and/or received from one or more network servers or other devices via one or more wired or wireless networks. The memory 920 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 900 can support one or more input devices 930, such as a touchscreen 932, microphone 934, camera 936, physical keyboard 938, trackball 940, and/or motion sensor 942; and one or more output devices 950, such as a speaker 952 and a display 954. Other possible output devices (not shown) can include piezoelectric or other haptic output devices. Some devices can serve more than one input/output function. For example, touchscreen 932 and display 954 can be combined in a single input/output device.

The input devices 930 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3-D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 912 or applications 914 can comprise speech-recognition software as part of a voice user interface that allows a user to operate the device 900 via voice commands. Further, the device 900 can comprise input devices and software that allows for user interaction via a user's spatial gestures, such as detecting and interpreting gestures to provide input to a gaming application.

A wireless modem 960 can be coupled to an antenna (not shown) and can support two-way communications between the processor 910 and external devices, as is well understood in the art. The modem 960 is shown generically and can include a cellular modem for communicating with the mobile communication network 904 and/or other radio-based modems (e.g., Bluetooth 964 or Wi-Fi 962). The wireless modem 960 is typically configured for communication with one or more cellular networks, such as a GSM network for data and voice communications within a single cellular network, between cellular networks, or between the mobile device and a public switched telephone network (PSTN).

The mobile device can further include at least one input/output port 980, a power supply 982, a satellite navigation system receiver 984, such as a Global Positioning System (GPS) receiver, an accelerometer 986, and/or a physical connector 990, which can be a USB port, IEEE 1394 (FireWire) port, and/or RS-232 port. The illustrated components 902 are not required or all-inclusive, as any components can be deleted and other components can be added.

### XII. Cloud-Supported Environment

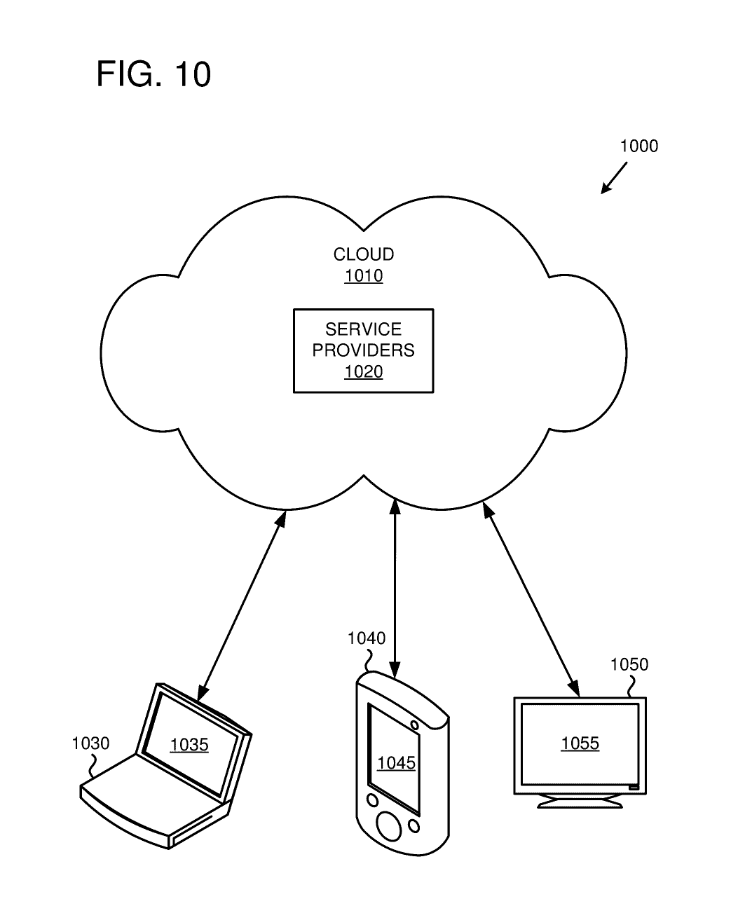

FIG. 10 illustrates a generalized example of a suitable cloud-supported environment 1000 in which described embodiments, techniques, and technologies may be implemented. In the example environment 1000, various types of services (e.g., computing services) are provided by a cloud 1010. For example, the cloud 1010 can comprise a collection of computing devices, which may be located centrally or distributed, that provide cloud-based services to various types of users and devices connected via a network such as the Internet. The implementation environment 1000 can be used in different ways to accomplish computing tasks. For example, some tasks (e.g., processing user input and presenting a user interface) can be performed on local computing devices (e.g., connected devices 1030, 1040, 1050) while other tasks (e.g., storage of data to be used in subsequent processing) can be performed in the cloud 1010.

In example environment 1000, the cloud 1010 provides services for connected devices 1030, 1040, 1050 with a variety of screen capabilities. Connected device 1030 represents a device with a computer screen 1035 (e.g., a mid-size screen). For example, connected device 1030 could be a personal computer such as desktop computer, laptop, notebook, netbook, or the like. Connected device 1040 represents a device with a mobile device screen 1045 (e.g., a small size screen). For example, connected device 1040 could be a mobile phone, smart phone, personal digital assistant, tablet computer, and the like. Connected device 1050 represents a device with a large screen 1055. For example, connected device 1050 could be a television screen (e.g., a smart television) or another device connected to a television (e.g., a set-top box or gaming console) or the like. One or more of the connected devices 1030, 1040, and/or 1050 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1000. For example, the cloud 1010 can provide services for one or more computers (e.g., server computers) without displays.

Services can be provided by the cloud 1010 through service providers 1020, or through other providers of online services (not depicted). For example, cloud services can be customized to the screen size, display capability, and/or touchscreen capability of a particular connected device (e.g., connected devices 1030, 1040, 1050).

In example environment 1000, the cloud 1010 provides the technologies and solutions described herein to the various connected devices 1030, 1040, 1050 using, at least in part, the service providers 1020. For example, the service providers 1020 can provide a centralized solution for various cloud-based services. The service providers 1020 can manage service subscriptions for users and/or devices (e.g., for the connected devices 1030, 1040, 1050 and/or their respective users).

### XIII. Additional Examples of the Disclosed Technology

In some examples of the disclosed technology, an apparatus includes a processor configured to execute one processor instruction having an input operand with the processor by producing two or more function values by performing two or more table lookups based at least in part on the input operand, generating an output value based on the two or more function values, and producing the output value as an output operand of the one processor instruction. In some examples, the output value is generated based at least in part on interpolating the two or more function values.

In some examples of the apparatus, the input operand is expressed as a fixed-point number including an index portion and a fractional portion, and the generating including interpolating the two or more function values and scaling, by the fractional portion, a difference computed between at least two of the two or more function values. In some examples, the input operand is expressed as a fixed-point number including an index portion and a fractional portion, and the index portion of the input operand is used to form an address for performing the two or more table lookups. In some examples, the input operand includes a portion of a vector of two or more input operands and the one processor instruction executes to process the vector, a respective set of two or more function values are produced for each of the two or more input operands of the vector, output values are interpolated and produced for each respective set of two or more function values, and the one processor instruction produces output values as a vector output operand.

In some examples, the one processor instruction includes a second operand specifying an offset from an index portion of the first input operand, and the offset is used to perform at least one of the two or more table lookups. In some examples, the two or more function values are not architecturally visible. In some examples, the processor is further configured to execute another processor instruction that stores values in a lookup table, the lookup table being used for providing the two or more function values produced by performing the two or more table lookups.

In some examples, the processor is further configured to, after executing the one processor instruction, execute one or more processor instructions that cause the processor to store at least one different value in a lookup table that was used for the two or more table lookups, and execute a third, single processor instruction having a second input operand with the processor by: producing two or more second function values by performing two or more table lookups in the lookup table based at least in part on the second operand, interpolating a second output value based on the two or more second function values, and producing the second output value as a second output operand of the third processor instruction.

In some examples of the disclosed technology, an apparatus including a processor includes: a lookup table configured to return one or more function values based on one or more input operands of a processor instruction, a control unit configured to execute the instruction by acts including addressing the lookup table based at least in part on the one or more input operands, and an interpolation module configured to interpolate at least one output value based on two or more of the returned function values.

In some examples, the apparatus further includes a load store unit configured to store the output value in memory and/or a processor register specified by an output operand of the processor instruction.

In some examples, the input operands are vector operands, and the at least one output value is stored as stored in a processor register as a vector operand. In some examples, the processor is configured to execute at least one or more of the following: vector instructions, single instruction multiple data (SIMD) instructions, multiple instruction multiple data (MIMD) instructions, and/or graphic processing unit (GPU) instructions. In some examples, addressing the lookup table includes performing at least one or more of the following when calculating an address for the lookup table when the lookup table returns at least one of the function values: clamping the address, wrapping the address, or limiting the address to a portion but not all available address locations for the lookup table. In some examples, the interpolation module includes at least one or more of the following: an adder, a multiplier, and/or a shifter.

In some examples of the disclosed technology, a method includes transforming one or more source code or assembly code instructions into processor instructions executable by the processor and emitting object code for the processor instructions, the processor code instructions including the single instruction that when executed by the processor, causes the processor perform a method including producing two or more function values by performing two or more table lookups based at least in part on the input operand, generating an output value based on the two or more function values, and producing the output value as an output operand of the one processor instruction. In some examples of the method, the input operand and the output operand are vectors of fixed-point data. In some examples, the method further includes executing one or more instructions different than the single instruction to store values in one or more lookup tables, and the two or more table lookups produce function values based at least in part on the stored values in the one or more lookup tables.

In some examples of the disclosed technology, a method includes transforming one or more source code or assembly code instructions into processor instructions executable by the processor and emitting object code for the processor instructions, the processor instructions including the single instruction that when executed by the processor, causes the processor to perform a method, the method including transforming one or more source code or assembly code instructions into processor instructions executable by the processor and emitting object code for the processor instructions, the processor code instructions including the single instruction that when executed by the processor, causes the processor perform a method including producing two or more function values by performing two or more table lookups based at least in part on the input operand, generating an output value based on the two or more function values, and producing the output value as an output operand of the one processor instruction. For example, the processor instructions can be executed by any of the the exemplary apparatus disclosed herein.

In some examples of the disclosed technology, one or more computer-readable storage media storing computer-executable instructions that when executed by a processor, cause the processor to perform a method including producing two or more function values by performing two or more table lookups based at least in part on the input operand, generating an output value based on the two or more function values, and producing the output value as an output operand of the one processor instruction. In some examples, the computer-readable storage media store instructions for transforming one or more source code or assembly code instructions into processor instructions executable by the processor and emitting object code for the processor instructions including a single instruction that cause a processor to perform a method including producing two or more function values by performing two or more table lookups based at least in part on the input operand, generating an output value based on the two or more function values.

In view of the many possible embodiments to which the principles of the disclosed subject matter may be applied, it should be recognized that the illustrated embodiments are only preferred examples should not be taken as limiting the scope of claims to those preferred examples. Rather, the claimed subject matter is defined by the following claims. We therefore claim as our invention all that comes within the scope of these claims.

We claim:

1. An apparatus comprising a processor, the processor being configured to:
execute one processor instruction having an input operand with the processor by:
producing two or more function values by performing two or more table lookups based at least in part on the input operand;
generating an output value based at least in part on interpolating the two or more function values; and
producing the output value as an output operand of the one processor instruction.

2. The apparatus of claim 1, wherein the input operand is expressed as a fixed-point number including an index portion and a fractional portion, and wherein the generating including interpolating the two or more function values and scaling, by the fractional portion, a difference computed between at least two of the two or more function values.

3. The apparatus of claim 1, wherein the input operand is expressed as a fixed-point number including an index portion and a fractional portion, and wherein the index portion of the input operand is used to form an address for the performing the two or more table lookups.

4. The apparatus of claim 1, wherein:
the input operand comprises a portion of a vector of two or more input operands and the one processor instruction executes to process the vector;
a respective set of two or more function values are produced for each of the two or more input operands of the vector;
output values are interpolated and produced for each respective set of two or more function values; and
the one processor instruction produces output values as a vector output operand.

5. The apparatus of claim 1, wherein:
the input operand is a first input operand;
the one processor instruction includes a second operand specifying an offset from an index portion of the first input operand; and
the offset is used to perform at least one of the two or more table lookups.

6. The apparatus of claim 1, wherein the two or more function values are not architecturally visible.

7. The apparatus of claim 1, wherein the processor is further configured to:
execute another processor instruction that stores values in a lookup table, the lookup table being used for providing the two or more function values produced by performing the two or more table lookups.

8. The apparatus of claim 1, wherein the processor is further configured to, after the executing the one processor instruction:
execute one or more processor instructions that cause the processor to store at least one different value in a lookup table that was used for the two or more table lookups; and
execute a third, single processor instruction having a second input operand with the processor by:
producing two or more second function values by performing two or more table lookups in the lookup table based at least in part on the second operand,
interpolating a second output value based on the two or more second function values, and
producing the second output value as a second output operand of the third processor instruction.

9. An apparatus comprising a processor, the processor comprising:
a lookup table configured to return one or more function values based on one or more input operands of a processor instruction;
a control unit configured to execute the instruction by acts including addressing the lookup table based at least in part on the one or more input operands; and
an interpolation module configured to interpolate at least one output value based on two or more of the returned function values.

10. The apparatus of claim 9, further comprising a load store unit configured to store the output value in memory and/or a processor register specified by an output operand of the processor instruction.

11. The apparatus of claim 9, wherein:
the input operands are vector operands; and
the at least one output value is stored in a processor register as a vector operand.

12. The apparatus of claim 9, wherein the processor is configured to execute at least one or more of the following: vector instructions, single instruction multiple data (SIMD) instructions, multiple instruction multiple data (MIMD) instructions, or graphic processing unit (GPU) instructions.

13. The apparatus of claim 9, wherein the lookup table is configured by performing at least one or more of the following to calculate an address for the lookup table: clamping the address, wrapping the address, or limiting the address to a portion of, but not all, available address locations for the lookup table.

14. The apparatus of claim 9, wherein the interpolation module includes means for interpolating the output value based on the input operands.

15. The apparatus of claim 9, wherein the interpolation module includes at least one or more of the following: an adder, a multiplier, or a shifter.

16. A method of operating a processor, the method comprising:
by executing a single instruction with the processor:
producing function values by performing two or more table lookups based at least in part on an input operand of the processor instruction;
interpolating an output value based on the function values; and
generating an output operand of the processor instruction based on the output value produced by interpolating.

17. The method of claim 16, wherein the input operand and the output operand are vectors of fixed-point data.

18. The method of claim 16, wherein the method further comprises:
executing one or more instructions different than the single instruction to store values in one or more lookup tables, wherein the two or more table lookups produce function values based at least in part on the stored values in the one or more lookup tables.

19. A method, comprising:
transforming one or more source code or assembly code instructions into processor instructions executable by the processor and emitting object code for the processor instructions, the processor instructions including the single instruction that when executed by the processor, causes the processor to perform the method of claim 16.

20. One or more computer-readable storage media storing computer-executable instructions that when executed by a processor, cause the processor to perform the method of claim 16.
